(19) United States
(12) Patent Application Publication
(10) Pub. No.: US 2026/0149203 A1
(43) Pub. Date: May 28, 2026

(54) CABLE SET

(71) Applicant: Murata Manufacturing Co., Ltd., Nagaokakyo-shi (JP)

(72) Inventor: Masataka FURUNO, Nagaokakyo-shi (JP)

(73) Assignee: Murata Manufacturing Co., Ltd., Nagaokakyo-shi (JP)

(21) Appl. No.: 19/452,892

(22) Filed: Jan. 20, 2026

Related U.S. Application Data
(63) Continuation of application No. PCT/JP2024/009445, filed on Mar. 11, 2024.

(30) Foreign Application Priority Data
Jul. 26, 2023 (JP) 2023-121765

(51) Int. Cl. H01R 12/71

(52) U.S. Cl. CPC H01R 12/716

(57) ABSTRACT

A cable set includes a first connector, a second connector, a first cable, and a second cable. The first cable includes a first terminal fixed to the first connector and a second terminal fixed to the second connector, and electrically connects the first connector and the second connector. The second cable includes a third terminal fixed to the first connector and a fourth terminal fixed to the second connector, and electrically isolates at least one of the first connector and the second connector. The length of the second cable between the third terminal and the fourth terminal is shorter than the length of the first cable between the first terminal and the second terminal.

### CROSS-REFERENCE TO RELATED APPLICATIONS

This application is a Continuation of International Patent Application No. PCT/JP2024/009445, filed on Mar. 11, 2024, which claims the benefit of priority to Japanese Patent Application No. 2023-121765, filed on Jul. 26, 2023, the entire contents of both of which are incorporated herein by reference.

### TECHNICAL FIELD

The present disclosure relates to a cable set that includes a plurality of cables and connectors to which opposite ends of the plurality of cables are connected.

### BACKGROUND ART

Patent Document 1 discloses a cable connection structure for electronic devices, and the cable connection structure includes a plurality of cables, connector sockets, and a bundling member. The plurality of cables includes dummy cables and cables for true wiring.

One ends of the cables for true wiring and one ends of the dummy cables are inserted in respective connector sockets and are fixed thereto. The cables for true wiring and the dummy cables are bundled using a bundling member.

### CITATION LIST

### Patent Document

Patent Document 1: Japanese Unexamined Patent Application Publication No. 9-245927

### SUMMARY

According to an embodiment, a cable set includes a first connector, a second connector, a first cable, and a second cable. The first cable includes a first terminal fixed to the first connector and a second terminal fixed to the second connector, and the first cable electrically connects the first connector and the second connector. The second cable includes a third terminal fixed to the first connector and a fourth terminal fixed to the second connector, and the second cable electrically isolates at least one of the first connector and the second connector. The length of the second cable between the third terminal and the fourth terminal is shorter than the length of the first cable between the first terminal and the second terminal.

### BRIEF DESCRIPTION OF DRAWINGS

FIG. 1(A) is a plan view illustrating an example of a cable set according to a first embodiment, and FIG. 1(B) is an end view of the example of the cable set of the first embodiment.

FIG. 2 is a perspective view illustrating the exterior of the example of the cable set of the first embodiment.

FIG. 3 is a perspective view illustrating part of a power supply system that utilizes the cable set according to an embodiment of the present invention.

FIG. 4 is a plan view illustrating an example of a cable set according to a second embodiment.

FIG. 5 is a plan view illustrating an example of a cable set according to a third embodiment.

FIG. 6 is a plan view illustrating an example of a cable set according to a fourth embodiment.

FIG. 7 is a plan view illustrating a structure including a cable set according to a derivative example.

### DESCRIPTION OF EMBODIMENTS

In conventional cable wiring structures, when a worker touches a cable during work, the cables used for electrical connection may receive stress due to tension. This may cause disconnection or breakage.

Accordingly, the present disclosure is directed to providing a cable set that can reduce the occurrence of unwanted stress generated by an external cause in cables that serve for electrical connection.

### First Embodiment

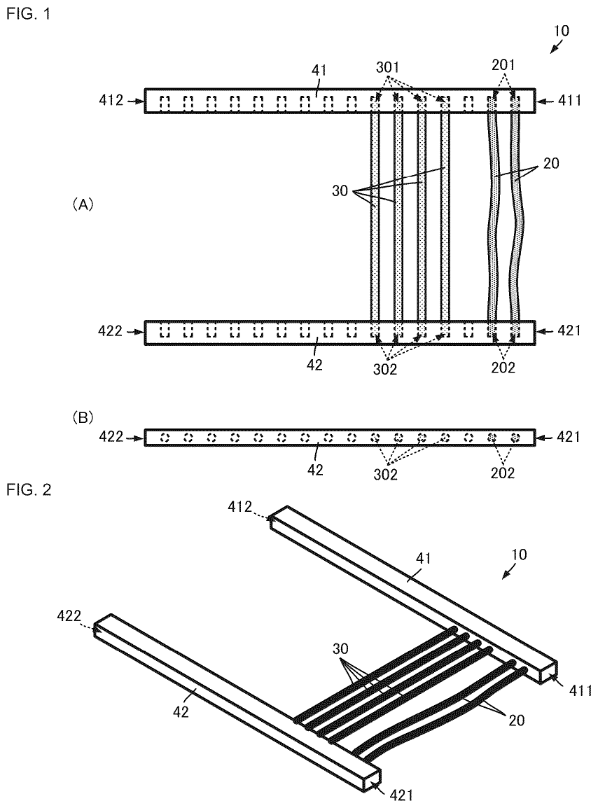

A cable set according to a first embodiment of the present invention will be described with reference to the drawings. FIG. 1(A) is a plan view illustrating an example of a cable set of the first embodiment, and FIG. 1(B) is an end view of the example of the cable set of the first embodiment. FIG. 2 is a perspective view illustrating the exterior of the example of the cable set of the first embodiment.

As illustrated in FIGS. 1(A), 1(B), and 2, a cable set 10 includes multiple first cables 20, multiple second cables 30, a first connector 41, and a second connector 42.

Each one of the first cables 20 and the second cables 30 is structured such that a conductive wire is covered with an insulator. The first cable 20 and the second cable 30 are made of the same materials. Note that the materials may be different between the first cable 20 and the second cable 30. The first cable 20 and the second cable 30 may have the same flexibility or may have different flexibilities. The flexibility of the second cable 30 may be equal to or lower than that of the first cable 20.

The first connector 41 includes a main body having insulating properties. For example, the main body is elongated in one direction and has an end surface 411 at one end and an end surface 412 at the other end in the longitudinal direction. The main body of the first connector 41 has multiple conductive sockets (hereinafter referred to simply as “sockets” or “contacts”) formed therein. The sockets are arrayed in the longitudinal direction with a space provided between adjacent sockets.

The second connector 42 has the same structure as that of the first connector 41. The main body of the second connector 42 has an end surface 421 at one end and an end surface 422 at the other end in the longitudinal direction. The main body of the second connector 42 has multiple sockets formed therein, which is similar to the main body of the first connector 41. The sockets are arrayed in the longitudinal direction with a space provided between adjacent sockets.

One ends of the first cables 20 are fixed, and electrically connected, to respective sockets of the first connector 41. More specifically, the one ends of the first cables 20 are connected to the sockets near the end surface 411.

The end portion of each first cable 20 connected and fixed to the first connector 41 is referred to as a first terminal 201 of the first cable 20.

The other ends of the first cables 20 are fixed, and electrically connected, to respective sockets of the second connector 42. More specifically, the other ends of the first cables 20 are connected to the sockets positioned near the end surface 421.

The end portion of each first cable 20 connected and fixed to the second connector 42 is referred to as a second terminal 202 of the first cable 20.

One ends of the second cables 30 are fixed to respective sockets of the first connector 41. More specifically, the one ends of the second cables 30 are connected to the sockets positioned closer to the end surface 412 than the sockets to which the first cables 20 are fixed.

The end portion of each second cable 30 connected and fixed to the first connector 41 is referred to as a third terminal 301 of the second cable 30.

The other ends of the second cables 30 are fixed to respective sockets of the second connector 42. More specifically, the other ends of the second cables 30 are connected to the sockets positioned closer to the end surface 422 than the sockets to which the first cables 20 are fixed.

The end portion of each second cable 30 connected and fixed to the second connector 42 is referred to as a fourth terminal 302 of the second cable 30.

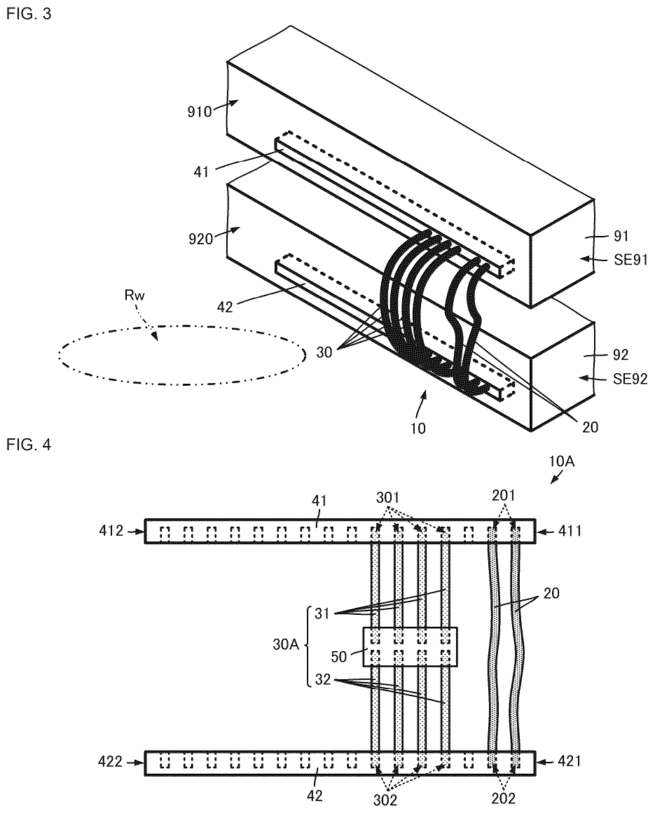

The cable set 10 structured as described above is used, for example, as illustrated in FIG. 3. FIG. 3 is a perspective view illustrating part of a power supply system that utilizes the cable set according to an embodiment of the present invention.

As illustrated in FIG. 3, the power supply system includes multiple power-supply shelves 91 and 92. The power-supply shelves 91 and 92 are installed in a rack. For example, as illustrated in FIG. 3, the power-supply shelf 91 is disposed above the power-supply shelf 92 in the rack.

A rear surface 910 of the power-supply shelf 91 and a rear surface 920 of the power-supply shelf 92 are substantially at the same position in the horizontal direction. A side surface SE91 of the power-supply shelf 91 and a side surface SE92 of the power-supply shelf 92 are substantially at the same position in the horizontal direction.

A recessed connector is disposed at the rear surface of the power-supply shelf 91 at a position near the side surface SE91. A recessed connector is also disposed at the rear surface of the power-supply shelf 92 at a position near the side surface SE92.

The first connector 41 of the cable set 10 is fitted in the recessed connector of the power-supply shelf 91. The second connector 42 of the cable set 10 is fitted in the recessed connector of the power-supply shelf 92. The first cables 20 thereby connect the power-supply shelf 91 and the power-supply shelf 92 electrically. In other words, the first cables 20 are cables used for real wiring between the power-supply shelf 91 and the power-supply shelf 92. On the other hand, the second cables 30 are cables not involved in the electrical connection between the power-supply shelf 91 and the power-supply shelf 92. In other words, the second cables 30 are “dummy cables” or “stress-relief cables” that are not used for real wiring between the power-supply shelf 91 and the power-supply shelf 92.

In this configuration, when the cable set 10 is connected to the power-supply shelf 91 and the power-supply shelf 92, the first cables 20 are positioned closer to the side surfaces SE91 and SE92 than the second cables 30.

In the above configuration, the length of each second cable 30 between the third terminal 301 and the fourth terminal 302 (i.e., the length of dummy wiring) is smaller than the length of each first cable 20 between the first terminal 201 and the second terminal 202 (i.e., the length of true wiring). In other words, the length of each first cable 20 between the first terminal 201 and the second terminal 202 (i.e., the length of true wiring) is greater than the length of each second cable 30 between the third terminal 301 and the fourth terminal 302 (i.e., the length of dummy wiring).

Here, assume that a worker touches the second cables 30 and the first cables 20 and pulls them by mistake. In this case, the second cables 30 receive tensile stress (tension) preferentially because the second cables 30 are shorter than the first cables 20.

This can reduce the unwanted tension (stress) applied to the first cables 20. Accordingly, this can reduce the occurrence of breakage of the first cables 20.

Here, the first cables 20 and the second cables 30 are substantially the same cables. In other words, this eliminates the necessity of providing other members than those serving necessary electrical connection (for example, more rigid cables) in order to control the unwanted tension applied to the first cables 20. Accordingly, the unwanted tension applied to the first cables 20 can be reduced using a simple structure.

Moreover, in the cable set 10, the first cables 20 and the second cables 30 are disposed at the rear surfaces 910 and 920 in such a manner that the first cables 20 are positioned closer than the second cables 30 to the side surfaces SE91 and SE92, as illustrated in FIG. 3. In other words, the second cables 30 are positioned closer than the first cables 20 to a work region Rw where the worker normally works behind the rear surfaces of the power-supply shelves 91 and 92.

Accordingly, if the worker happened to touch a portion near the side surfaces SE91 and SE92, the worker would touch the second cables 30 first. This can reduce the occurrence of unwanted contact with the first cables 20, thereby reducing resultant breakage. While the example in FIG. 3 shows the second cables 30 positioned closer to the side surfaces, the disclosure is not limited to this orientation. The second cables 30 may generally be disposed at an outer perimeter or an accessible side of the cable set 10 relative to the first cables 20. In this arrangement, the second cables 30 physically intervene between the first cables 20 and an expected direction of external access. In other words, the shorter second cables 30 form a structural guard or buffer layer. This structural guard is positioned to intercept external physical contact before such contact reaches the first cables 20.

Note that the first cables 20 do not need to have the same length. The second cables 30 do not need to have the same length, either. In such cases, it is sufficient that the longest one of the second cables 30 is shorter than the shortest one of the first cables 20.

In addition, the number of the first cables 20 and the number of the second cables 30 are not limited to what is illustrated in the drawings (i.e., two first cables 20 and four second cables 30). The number of the first cables 20 is to be determined in accordance with the specification of the power supply system. The number of the second cables 30 may be such that the breakage of the first cables 20 can be reduced or prevented, e.g., may be greater than the number of the first cables 20.

The length of each second cable 30 may be 80% or more (and less than 100%) of the length of each first cable 20. This can prevent the length of the first cable 20 from becoming too great compared with the length of the second cable 30. This can reduce the likelihood of a worker happening to touch the first cables 20 first due to the first cables 20 being too long. Accordingly, the second cables 30 can reduce the likelihood of the first cables 20 receiving the unwanted tension more effectively.

With the above configuration, when the first cable and the second cable are pulled, a tensile stress tends to be generated in the second cable that is shorter than the first cable, while a tensile stress is not generated easily in the first cable. This can reduce an unwanted stress generated by an external cause in the first cable that serves for electrical connection.

### Second Embodiment

A cable set according to a second embodiment of the present disclosure will be described with reference to the drawings. FIG. 4 is a plan view illustrating an example of the cable set of the second embodiment.

As illustrated in FIG. 4, a cable set 10A of the second embodiment is different from the cable set 10 of the first embodiment in that the cable set 10A includes multiple second cables 30A that are split into two portions in the middle and also includes an insulating cover member 50. The structure of the cable set 10A except for the above is similar to that of the cable set 10, and the description of the same elements will be omitted.

The cable set 10A includes the second cables 30A and the insulating cover member 50. Each second cable 30A is structured such that the second cable 30 of the first embodiment is split into two portions, in other words, a second cable 31 and a second cable 32.

Multiple second cables 31 are connected and fixed to the first connector 41, and the end portions of the second cables 31 fixed to the first connector 41 are the third terminals 301. Multiple second cables 32 are connected and fixed to the second connector 42, and the end portions of the second cables 32 fixed to the second connector 42 are the fourth terminals 302.

The end portion of each second cable 31 opposite to the third terminal 301 is positioned so as to be closely spaced from, but not electrically connected to, the end portion of the corresponding second cable 32 opposite to the fourth terminal 302. The section where the second cable 31 and the second cable 32 are closely spaced from each other is referred to as a discontinuous section of the second cable 30A.

The insulating cover member 50 is formed so as to cover the end portions of the second cables 31 and the end portions of the second cables 32, both end portions being closer to the discontinuous section. Accordingly, the insulating cover member 50 physically connects and fixes the end portions of the second cables 31 to the end portions of the second cables 32, both end portions being closer to the discontinuous section.

For example, the insulating cover member 50 may be made of a heat-shrinkable tube having insulating properties.

With the above configuration, the cable set 10A can provide advantageous effects similar to those of the cable set 10, and the cable set 10A can reliably block the transmission of power and signals on the second cables 30A between the first connector 41 and the second connector 42.

Note that the flexibility of the portion of the second cable 30A that is covered by the insulating cover member 50 may be greater than the portion of the second cable 30A that is not covered by the insulating cover member 50.

In addition, a width of the insulating cover member 50 (i.e., the length of the insulating cover member 50 in the direction in which the second cables 30A are arrayed) may be greater than the transversal length, i.e., a combined width, of the second cables 30A when the second cables 30A are brought into contact with each other.

With the above configuration, the insulating cover member 50, which is vulnerable to unwanted contact, can direct the unwanted tension to the second cables 30A. Accordingly, the cable set 10A can reduce the occurrence of the unwanted tension applied to the first cables 20 more reliably.

### Third Embodiment

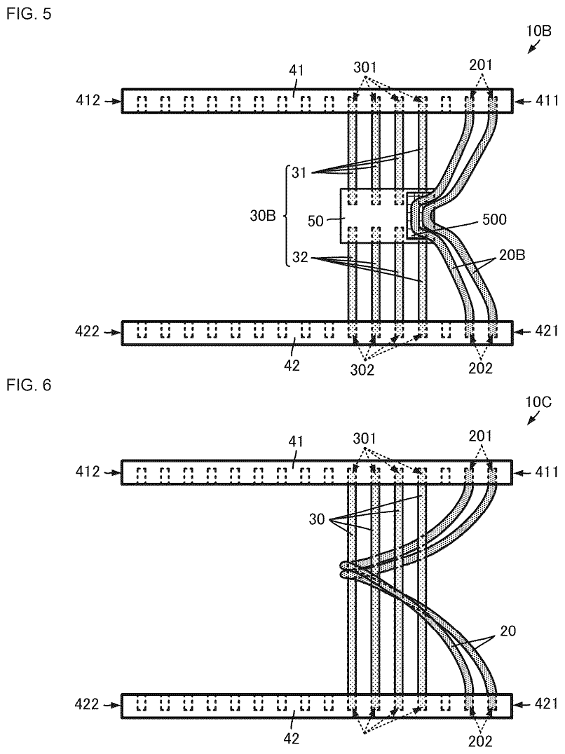

A cable set according to a third embodiment of the present disclosure will be described with reference to the drawings. FIG. 5 is a plan view illustrating an example of the cable set of the third embodiment.

As illustrated in FIG. 5, a cable set 10B of the third embodiment is different from the cable set 10A of the second embodiment in that the first cables 20 are adhered to the insulating cover member 50 in the cable set 10B. The structure of the cable set 10B except for the above is similar to that of the cable set 10A, and the description of the same elements will be omitted.

The cable set 10B includes multiple first cables 20B, multiple second cables 30B, and an adhesive 500. The second cables 30B have a structure similar to that of the second cables 30A.

The first cables 20B are adhered to the insulating cover member 50 using the adhesive 500. With this structure, the cable set 10B can reduce the likelihood of the first cables 20 solely receiving the unwanted tension.

The first cables 20B are adhered to the insulating cover member so as to allow the first cables 20B to bend to a certain degree. In other words, the first cables 20B are adhered to the insulating cover member so as not to follow the shortest lines drawn from the first terminals 201 or from the second terminals 202. Even if unwanted tension is applied to the insulating cover member 50 or to the second cables 30B, this structure can reduce the occurrence of the unwanted tension being directed to the first cables 20.

With the above configurations, the cable set 10B can provide advantageous effects similar to those of the cable set 10A, and the cable set 10B can reliably prevent the first cables 20 from solely receiving the unwanted tension.

Note that the adhesive 500 may be an adhesive, e.g., an elastic adhesive or a flexible adhesive, that enables elastic adhesion. The term “an adhesive that enables elastic adhesion” means that the hardened adhesive forms, for example, into a rubber-like elastic body. In other words, the hardened adhesive can exhibit a certain degree of softness and elasticity instead of achieving rigid adhesion. By using the adhesive enabling the elastic adhesion, the elasticity of the adhesive 500 can reduce the occurrence of the first cables 20B receiving unwanted tension even if the unwanted tension is applied to the second cables 30B and the insulating cover member 50.

### Fourth Embodiment

A cable set according to a fourth embodiment of the present disclosure will be described with reference to the drawings. FIG. 6 is a plan view illustrating an example of the cable set of the fourth embodiment.

As illustrated in FIG. 6, a cable set 10C of the fourth embodiment is different from the cable set 10C of the first embodiment in that the first cables 20 are wound around the second cables 30. The structure of the cable set 10C except for the above is similar to that of the cable set 10, and the description of the same elements will be omitted.

In the cable set 10C, the first cables 20 are wound around the second cable 30. In this case, the first cables 20 are wound loosely around the second cables 30. In other words, the first cables 20 are wound around so as not to constrict the second cables 30 and so as not to receive tension readily when the second cables 30 deform.

Accordingly, the cable set 10C can reduce the likelihood of the first cables 20 solely receiving the unwanted tension. Moreover, even if unwanted tension is applied to the second cables 30, the cable set 10C can reduce the likelihood of the unwanted tension being transmitted to the first cables 20.

### Derivative Example

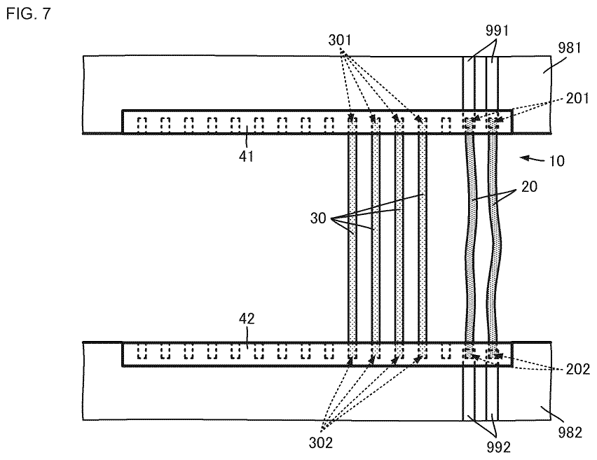

Various distinctive structures of the cable set have been described in the above embodiments. FIG. 7 illustrates other features that can be added to these structures.

FIG. 7 is a plan view illustrating a structure including a cable set according to a derivative example. As illustrated in FIG. 7, the structure includes the cable set 10, a circuit board 981, and a circuit board 982.

The first connector 41 of the cable set 10 is mounted on the circuit board 981. The circuit board 981 has multiple conductive traces 991 formed thereon. The circuit board 981 corresponds to a “first circuit board”, and the conductive traces 991 correspond to “first wiring traces”.

The conductive traces 991 are electrically connected to the sockets of the first connector 41 to which the first cables 20 are connected. The circuit board 981 does not have conductive traces that are electrically connected to the sockets of the first connector 41 to which the second cables 30 are connected. In other words, the third terminals 301 of the second cables 30 are electrically open.

The second connector 42 of the cable set 10 is mounted on the circuit board 982. The circuit board 982 has multiple conductive traces 992 formed thereon. The circuit board 982 corresponds to a “second circuit board”, and the conductive traces 992 correspond to “second wiring traces”.

The conductive traces 992 are electrically connected to the sockets of the second connector 42 to which the first cables 20 are connected. The circuit board 982 does not have conductive traces that are electrically connected to the sockets of the second connector 42 to which the second cables 30 are connected. In other words, the fourth terminals 302 of the second cables 30 are electrically open.

Accordingly, the structure that includes the cable set can reduce the occurrence of the unwanted tension applied to the first cables 20 and can reliably block the transmission of power and signals through the second cables 30.

The configurations of the above embodiments can be appropriately combined with one another, and resulted combinations can provide advantageous effects accordingly.

Note that the cable used for true wiring is a cable that can transmit necessary signals or power and the dummy cable is a cable that does not transmit necessary signals or power. In order to block the transmission of signals or power, the dummy cable may be isolated in the middle, or the trace to which the dummy cable is connected may be made open circuit.

If the dummy cable becomes conductive, the dummy cable transmits unnecessary signals or power, which is disadvantageous. In the case of the necessary signals or power being transmitted through the dummy cable, this leads to the disadvantage of a transmission failure occurring when the dummy cable happens to break due to tension. Accordingly, the dummy cable needs to be isolated in the middle or at the circuit board in order to block the transmission of signals or power therethrough.
<1> A cable set includes a first connector, a second connector, a first cable, and a second cable. The first cable includes a first terminal fixed to the first connector and a second terminal fixed to the second connector, and the first cable electrically connects the first connector and the second connector. The second cable includes a third terminal fixed to the first connector and a fourth terminal fixed to the second connector, and the second cable does not electrically connect the first connector and the second connector. A length of the second cable between the third terminal and the fourth terminal is shorter than a length of the first cable between the first terminal and the second terminal.
<2> In the cable set described in <1> above, a flexibility of the second cable is equal to or smaller than a flexibility of the first cable.
<3> In the cable set described in <1> or <2> above, a material of the first cable is the same as a material of the second cable.
<4> In the cable set described in any one of <1> to <3> above, the second cable is electrically discontinuous at a discontinuous section positioned midway between the third terminal and the fourth terminal, and the discontinuous section is covered by an insulating cover member.
<5> In the cable set described in <4> above, in the second cable, a flexibility of a portion covered by the insulating cover member is greater than a portion not covered by the insulating cover member.
<6> In the cable set described in <4> or <5> above, a width of the insulating cover member is greater than a transversal length of a plurality of the second cables that are arranged so as to be in contact with each other.
<7> In the cable set described in any one of <4> to <6> above, the first cable is adhered to the insulating cover member.
<8> In the cable set described in <7> above, the first cable is elastically adhered to the insulating cover member by means of elastic adhesion.
<9> In the cable set described in any one of <1> to <8> above, the first cable is wound around the second cable.
<10> In the cable set described in any one of <1> to <9> above, the length of the second cable between the third terminal and the fourth terminal is at least 80% of the length of the first cable between the first terminal and the second terminal.
<11> The cable set described in <1> above includes the first connector, the second connector, the first cable, the second cable, a first circuit board, and a second circuit board. The first cable includes the first terminal fixed to the first connector and the second terminal fixed to the second connector, and the first cable electrically connects the first connector and the second connector. The second cable includes the third terminal fixed to the first connector and the fourth terminal fixed to the second connector, and the second cable does not electrically connect the first connector and the second connector. The first connector is mounted on the first circuit board. The second connector is mounted on the second circuit board. The length of the second cable between the third terminal and the fourth terminal is shorter than the length of the first cable between the first terminal and the second terminal. The first circuit board includes a first wiring trace connected to the first terminal of the first connector. The second circuit board includes a second wiring trace connected to the second terminal of the second connector. The third terminal of the first connector and the fourth terminal of the second connector are electrically open.

### REFERENCE SIGNS LIST

10, 10A, 10B, 10C cable set
20, 20B first cable
30, 30A, 30B, 31, 32 second cable
41 first connector
42 second connector
50 insulating cover member
91, 92 power-supply shelf
201 first terminal
202 second terminal
301 third terminal
302 fourth terminal
411, 412, 421, 422 end surface
500 adhesive
910, 920 rear surface
981, 982 circuit board
991, 992 conductive trace
Rw work region
SE91 side surface
SE92 side surface

1. A cable set comprising:
a first connector;
a second connector;
a first cable that includes a first terminal fixed to the first connector and a second terminal fixed to the second connector, the first cable electrically connecting the first connector and the second connector; and
a second cable that includes a third terminal fixed to the first connector and a fourth terminal fixed to the second connector, the second cable being electrically isolated from at least one of the first connector and the second connector, wherein
a length of the second cable between the third terminal and the fourth terminal is shorter than a length of the first cable between the first terminal and the second terminal.

2. The cable set according to claim 1, wherein
a flexibility of the second cable is equal to or less than a flexibility of the first cable.

3. The cable set according to claim 1, wherein
a material of the first cable is the same as a material of the second cable.

4. The cable set according to claim 1, wherein
the second cable is electrically discontinuous at a discontinuous section positioned midway between the third terminal and the fourth terminal, and
the discontinuous section is covered by an insulating cover member.

5. The cable set according to claim 4, wherein
in the second cable, a flexibility of a portion covered by the insulating cover member is greater than a portion not covered by the insulating cover member.

6. The cable set according to claim 4, wherein
a width of the insulating cover member is greater than a combined width of a plurality of the second cables that are arranged so as to be in contact with each other.

7. The cable set according to claim 4, wherein
the first cable is adhered to the insulating cover member.

8. The cable set according to claim 7, wherein
the first cable is adhered to the insulating cover member by an elastic adhesive.

9. The cable set according to claim 1, wherein
the first cable is wound around the second cable.

10. The cable set according to claim 1, wherein
the length of the second cable between the third terminal and the fourth terminal is at least 80% of the length of the first cable between the first terminal and the second terminal.

11. A connection structure, comprising:
a cable set including:
a first connector;
a second connector;
a first cable that includes a first terminal fixed to the first connector and a second terminal fixed to the second connector, the first cable electrically connecting the first connector and the second connector; and
a second cable that includes a third terminal fixed to the first connector and a fourth terminal fixed to the second connector, the second cable being electrically isolated from at least one of the first connector and the second connector;
a first circuit board on which the first connector is mounted; and
a second circuit board on which the second connector is mounted, wherein
a length of the second cable between the third terminal and the fourth terminal is shorter than a length of the first cable between the first terminal and the second terminal,
the first circuit board includes a first wiring trace connected to the first terminal of the first connector,
the second circuit board includes a second wiring trace connected to the second terminal of the second connector, and
the third terminal of the first connector and the fourth terminal of the second connector are electrically open.

12. The connection structure according to claim 11, wherein the length of the second cable is defined such that the second cable receives a tensile stress prior to the first cable when the first connector and second connector are pulled apart.

13. The connection structure according to claim 11, wherein the first wiring trace transmits a signal or power, and the second cable is a dummy cable that does not transmit a signal or power.

14. The connection structure according to claim 11, wherein the first circuit board has a side surface, and the first cable is closer to the side surface of the first circuit board than the second cable.

15. The connection structure according to claim 11, wherein the first connector and the second connector are recessed connectors.

16. The connection structure according to claim 11, wherein the first cable and the second cable include wire conductors covered with insulators.

17. A cable set comprising:
a first connector;
a second connector;
a conductive first cable fixed to the first connector and the second connector; and
a second cable fixed to the first connector and the second connector;
wherein a total length of the second cable is shorter than a total length of the first cable,
wherein the second cable includes a first portion connected to the first connector and a separate second portion connected to the second connector, the first portion and the second portion being physically connected to each other via an insulating cover member such that the second cable is electrically discontinuous.

18. The cable set according to claim 17, wherein the conductive first cable is adhered to the insulating cover member.

19. The cable set according to claim 18, wherein the conductive first cable is adhered to the insulating cover member via an elastic adhesive.

20. The cable set according to claim 17, wherein the insulating cover member comprises a heat-shrinkable tube.
